(19) United States
(12) Patent Application Publication
(10) Pub. No.: US 2004/0031925 A1
(43) Pub. Date: Feb. 19, 2004

(54) Intelligent coincidence transmission source and method for using

(75) Inventors: J. Clifton Moyers, Oak Ridge, TN (US); John G. Hoffman, Knoxville, TN (US)

Correspondence Address: PITTS AND BRITTIAN P C, P O BOX 51295, KNOXVILLE, TN, 37950-1295, US

(73) Assignee: CTI PET Systems, Inc., Knoxville, TN

(21) Appl. No.: 10/222,091

(22) Filed: Aug. 16, 2002

(51) Int. Cl. G01T 1/164; G21G 4/00

(52) U.S. Cl. 250/363.03; 250/493.1

(57) ABSTRACT

An apparatus for providing source information to a positron emission tomography (PET) scanner upon demand, and a method for using same. An intelligent coincidence transmission source with multiple point sources includes data in a storage device. The data includes the date of manufacture, the activity level at that date, and other information. The data is provided to the scanner's computer system upon demand. The apparatus includes flexible means for maintaining electrical communication between the data storage device and the scanner.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to calibration sources used by tomography scanners such as positron emission tomography (PET). More particularly, this invention pertains to an apparatus and a method for automatically obtaining the identity and additional information pertaining to a radiation source installed in the scanner.

2. Description of the Related Art

Positron Emission Tomography (PET) has gained significant popularity in nuclear medicine because of its capability to non-invasively produce images of physiological processes within the body. PET allows the physician to examine the whole patient at once by producing images of many functions of the human body unobtainable by other imaging techniques. Applications employing the PET technology for its sensitivity and accuracy include those in the fields of oncology, cardiology and neurology.

A source of error in the data collected from PET scanners is related to the attenuation of the gamma radiation within the body being measured. By accurately measuring the gamma radiation attenuation along the emission lines of response (LORs), normalization coefficients can be determined and applied to correct the acquired data.

Attenuation correction in PET is required for quantitative assessment of tracer concentration within the human body. Over the years, numerous methods have been utilized to acquire this “transmission” data. Currently, all commercially used methods to measure attenuation within the body use one or more radioactive sources that are located outside the patient. In coincidence transmission methods, typically the isotope used in the transmission source is Ge⁶⁸, which has a 271 day half-life. Because the expected life of a PET scanner is generally much greater than 5 years (1800+days), these sources must be replaced over the life of the tomograph.

Numerous approaches have been implemented in various PET tomograph architectures to measure gamma radiation attenuation in the object being examined. Several coincidence-based measurement methods simulate either a ring or cylinder of positron radiation located just outside the envelope of the patient. These include ring source and rotating rod source based transmission systems. With a technique called rod-windowing, emission and transmission data can be acquired simultaneously, permitting better registration of emission and transmission data since there is less chance of patient motion occurring between the transmission and emission acquisitions.

Recently, single photon approaches have been implemented, where a collimated fan-beam point source is positioned axially to illuminate the emission LORs. This approach has the advantage of using a long half-life radiation isotope (Cs¹³⁷), requiring no maintenance over the life of the source. Additionally, the source activity can be significantly higher than the rod sources in a coincidence system because, unlike the prior coincidence transmission systems that used the tomograph detectors to register both photons of an annihilation event, this approach only requires detection of the attenuated photon. This technique overcomes the high dead-time implications for the near detector that limited the amount of activity that could be used in the prior systems. The capability to have a higher activity in the single photon approach allows for a shorter overall transmission acquisition time.

A disadvantage of single photon acquisition is that, because it does not use coincidence detection methods, techniques such as rod-windowing (used with coincidence rod-source transmission systems) cannot be applied to discriminate between the transmission source activity and activity that has been injected into the patient for the emission acquisition. To overcome this problem, an additional “mock” scan is required of single photon systems, negating much of the benefit of the higher transmission activity.

Another transmission source uses a point source similar to the single photon point source, except that it is loaded with a positron isotope, such as Ge⁶⁸ or Na²², and has a high-speed detector adjacent to the source. The high-speed detector collects the second photon of the annihilation event. Fast signal processing electronics record these local detector events and perform coincidence measurements in a method similar to the acquisition of emission coincidence measurements. This system has the simultaneous emission/transmission acquisition benefits of the previous coincidence transmission systems (separation of emission from transmission events), with the additional benefit of avoiding the near-detector dead-time associated with the prior methods. As a coincidence system that uses a dedicated local high-speed detector, much higher transmission source activity levels may be employed, permitting acquisition of higher quality transmission data.

As with the prior transmission systems, this system employs positron isotopes for radiation sources. As described previously, these positron-emitting isotopes suffer from relatively short half-life, for example, 0.742 years for Ge⁶⁸ and 2.66 years for Na²². The diminishing source activity can lead to errors in quantification in PET scanning. Thus, it is important that the transmission sources be replaced at a regular interval to insure adequate isotope activity to support quality transmission imaging. Furthermore, for accurate quantitative PET measurements, it is important to know the source activity at the time a scan is performed.

Present coincidence transmission systems lack an automated way for accounting for source activity whenever the sources are changed. When new sources are placed in the tomograph, a manual notation must be made of the source manufacture date and the activity level of each source. This burden is significantly exacerbated by the number of source assemblies in the tomograph.

### BRIEF SUMMARY OF THE INVENTION

An intelligent coincidence transmission source and a method for using this source are provided. An intelligent coincidence transmission source is attached to a tomograph. The source includes means for storing data, including a date, the activity of the source on that date, and optionally, a serial number or other identification codes. Also included are means for connecting the means for storing the data to the tomograph computer. The tomograph computer reads the data stored in the source. In one embodiment, the means for storing the data includes a programmable memory device. The means for connecting includes a flexible cable attached to an interface unit including the data storage device and having a connector at the other end for connecting to another cable or device that communicates with the scanner computer.

The method includes the steps of measuring the activity of the sources included in the intelligent coincidence transmission source, storing data relating to the sources in the transmission source, installing the transmission source in a scanner, connecting the data storage device in the transmission source to the scanner computer, having the computer read the data storage device, and having the computer act on the stored data that was retrieved.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a scanner showing a patient bed;

FIG. 2 is a section view of the scanner showing the detectors and an intelligent radiation source;

FIG. 3 is a cut-away view of PET scanner showing the orientation of an intelligent radiation source;

FIG. 4 is a plan view of a portion of the intelligent radiation source with a point source head;

FIG. 5 is a perspective view of an end of the intelligent radiation source showing the flexible circuit and point source head;

FIG. 6 is a front view of the scanner gantry showing the radiation path from the source; and

FIG. 7 is a flow chart of the process of storing and obtaining source data.

### DETAILED DESCRIPTION OF THE INVENTION

An intelligent coincidence transmission source and a method for using this source are disclosed. An intelligent coincidence transmission source (shown generally in the figures as 10) is attached to a tomograph gantry 120.

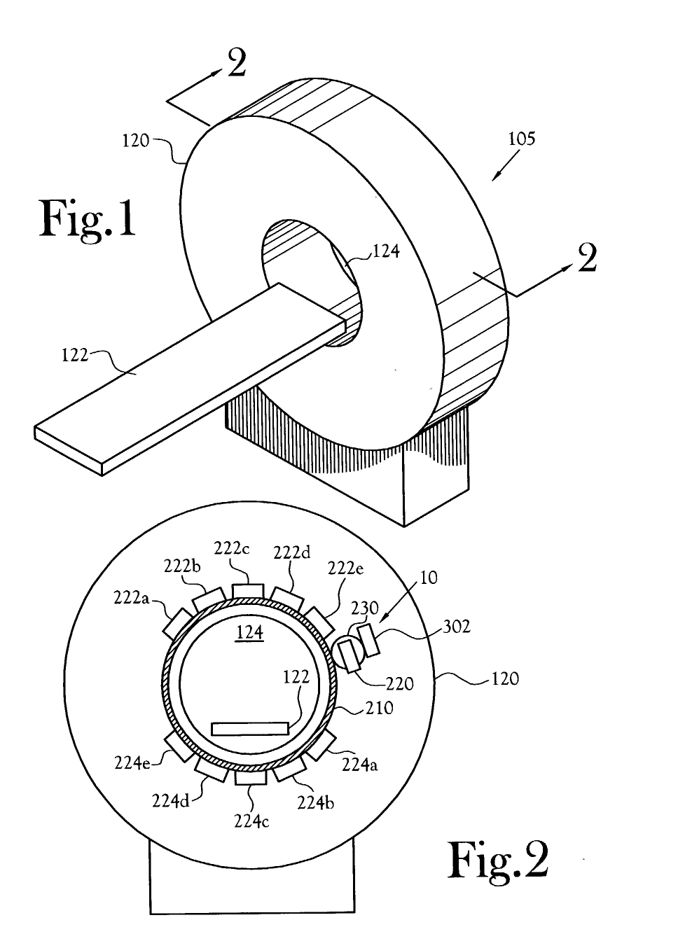

FIG. 1 illustrates a PET scanner 105, including a tomograph gantry 120, a patient bed 122, and a patient tunnel 124. FIG. 2 is a front section view of the gantry 120 showing two sets of emission detectors 222, 224 and an intelligent coincidence transmission source 10. The illustrated embodiment is shown with a partial ring rotating tomograph. Other embodiments include a full ring, stationary tomograph with slip rings used to pass the electrical signals. The source 10 is positioned opposite the target set of emission detectors 224. A point source head 220 is visible in front of the source collimator/shield 230 along with one near detector 302. Although only a single source 10 is illustrated, in another embodiment, multiple sources are used, being spaced about the gantry 120.

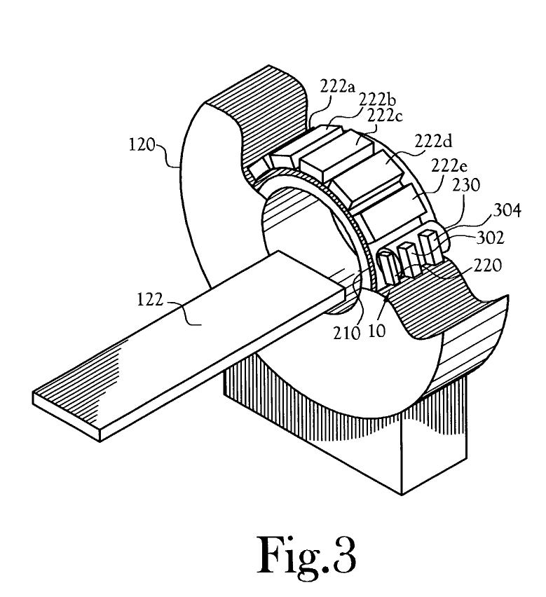

FIG. 3 is a cut-away perspective view of the tomograph gantry 120 showing the detectors 222 mounted on a support 210 and with a source 10 adjacent to the detectors 222. This figure shows two near source detectors 302, 304 mounted on a source shield/collimator 230. Those skilled in the art will recognize that multiple sources and near detectors may be used without departing from the spirit and scope of this invention. Typically, a single near detector 302 is used for each point source in the point source rod 422.

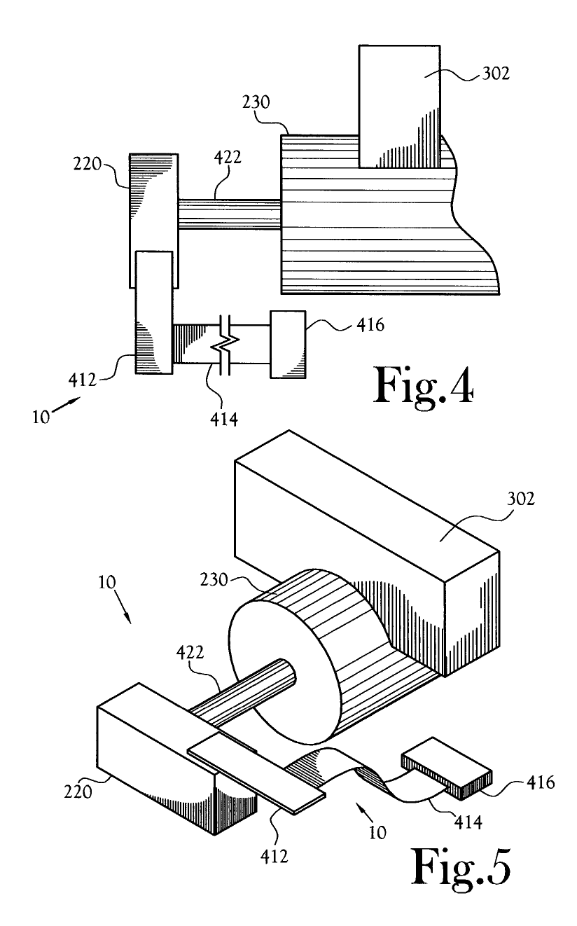

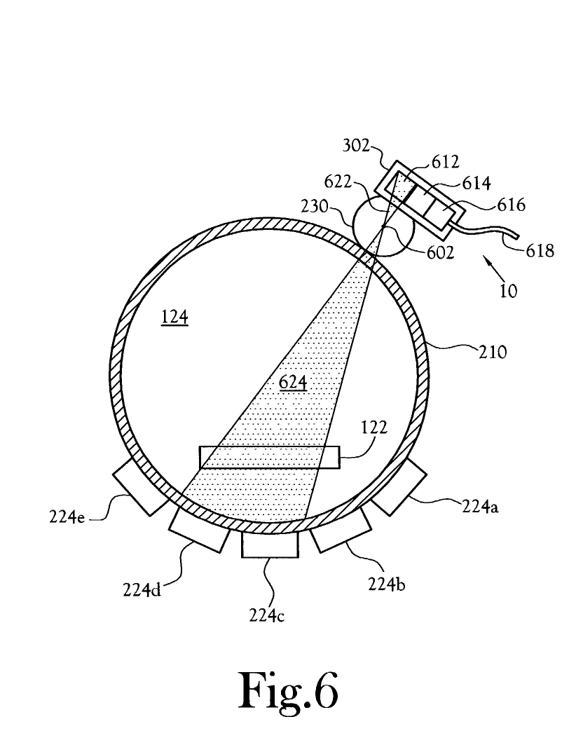

FIG. 4 illustrates an end of the source collimator/shield 230 with a point source head 220. FIG. 5 illustrates a perspective view of the apparatus illustrated in FIG. 4. The point source head 220 is shown attached to the point source rod 422, which is configured to be inserted into the source collimator/shield 230. The point source rod 422 is a rod with one or more point sources (not illustrated) along its length. As the rod 422 is inserted into the collimator 230, the point sources become aligned with collimator windows, which allow the radiation from the point sources to be detected by the near detectors 302, 304 and the scanner detectors 224. In one embodiment, the point source rod 422 contains 10 point sources, although those skilled in the art will recognize that the number of point sources can vary without departing from the spirit and scope of this invention. Although only two near detector assemblies 302, 304 are illustrated in FIG. 3, those skilled in the art will recognize that each radiation point source in the point source rod 422 has a corresponding near detector assembly 302.

FIGS. 4 and 5 show partial side and perspective views of an intelligent coincidence transmission source 10. Connected to the point source head 220 is a single interface module 412, which includes a non-volatile data storage and interface device which enables communication between the interface module and an external computer, such as that used for the scanner 105. The interface module 412 contains a data storage circuit for storing the data relating to the point sources and an interface circuit for reading the data from the data storage circuit and communicating with the scanner's computer. The data stored includes the date, either the date of manufacture or the date of testing, the activity level of each point source on that date, and optionally, other information, for example, a unique identifier for each point source and/or data identifying the scanner model in which the source 10 is to be installed. In another embodiment, the non-volatile data storage and interface device is attached in various places on either the point source rod 422 or the collimator 230, depending upon the configuration of the rod 422 and collimator 230 system. The non-volatile memory is any of various devices capable of storing data, such as a group of switches, a PROM, an EPROM, an EEPROM, a bar code label, or other device that permits writing and storing that data such that the data is stored for the life of the source 10.

Connected to the interface module 412 is a flexible cable 414 terminated in a connector 416, which connects the interface module 412 to the computer system of the scanner 105. The flexible cable 414 permits the point source head 220 to travel axially with respect to the collimator 230 while maintaining electrical communication with the computer system of the scanner 105. In one embodiment, the interface module 412 is a printed circuit board with a programmable memory device containing the source data. In another embodiment, the interface module 412 is a rigid section of flexible circuit. In still another embodiment, which may be combined with one of the other embodiments, the flexible cable 414 is a flexible circuit. In another embodiment, a radio frequency data link is used, which permits the interface circuit portion of the interface module 412 to be mounted away from the data storage circuit, which is attached to or a part of the point source head 220. In still another embodiment, a bar code or other optically readable label is used as the non-volatile memory with an optical reader used, which permits the interface circuit portion of the interface module 412 to be mounted away from the data storage circuit, which is attached to or a part of the point source head 220.

FIG. 6 illustrates the radiation source in operation. An aperture in the collimator 230 is axially aligned with a point source 602 in the point source rod 422 such that the radiation 622, 624 emanating from the point source 602 can be detected by the near detector 302 and the tomograph emission detectors 224. The near detector 302 includes a scintillator crystal 612, such as lutetium oxyorthosilicate (LSO), which is optically coupled to a photodetector 614, such as a photomultiplier tube, and a detector base 616. The detector base 616 has a cable 618, which connects to the scanner processor (not shown).

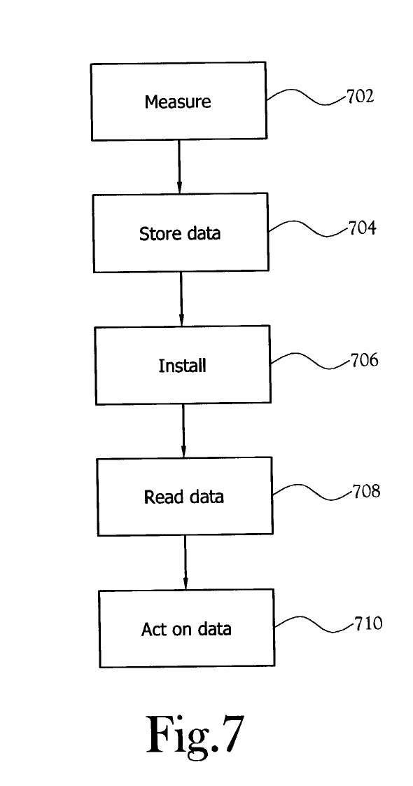

FIG. 7 is a flow chart of the method for using the intelligent coincidence transmission source. The first step is to determine the activity level 702 of each point source 602 within the point source rod 422. The measurement step 702 includes measuring and recording the date and time of measurement of each point source activity level. In one embodiment, this determination is made by measuring the activity level either during manufacturing or at a later date. The second step is to store the data 704 from the measurements. The store data step 704 includes storing the measurement information in a non-volatile memory device, which in one embodiment is located in the interface module 412. The data includes the activity level determined for each point source 602 and the date each activity level was determined. In another embodiment, the data also includes identifying serial numbers for the radiation point sources and an identifier for the tomograph scanner 105 in which the transmission source is to be installed. The next step is to install the transmission source 706 in the tomograph scanner 105. Installation includes physically mounting the source in the scanner 105 and connecting the source 10 to the scanner's computer system.

Once installed, a computer system reads the data 708 stored in the source 10 and the computer system then acts on that data 710. The read data step 708 includes the electronics system of the tomograph accessing the stored data and transferring the data to the tomograph computer system. The act on data step 710 includes the actions taken by the tomograph computer system, via its software, based on the data read in step 708. Actions taken by the computer system include making the data available to the PET scanner system software, verifying that the correct source 10 has been installed in the scanner 105, making source-strength correction calculations based on the data stored in the source 10, notifying an operator when the source 10 is nearing replacement time, blocking use of the scanner 105 if the source 10 is not within usable limits or the source 10 is the wrong model for the scanner, and using the source 10 serial number for source traceability for regulatory purposes. Those skilled in the art will recognize that the actions taken by the computer system may vary without departing from the spirit and scope of the present invention.

From the forgoing description, it will be recognized by those skilled in the art that an apparatus and a method for using the apparatus have been provided. An intelligent coincidence transmission source provides data to the scanner's computer system upon demand, and a method is provided for using this source in a tomograph scanner.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. An apparatus for automatically providing source data for a radiation source, said apparatus comprising:
a coincidence transmission source having a point source rod with at least one point source;
a data storage device associated with said coincidence transmission source, said data storage device storing a date and a point source activity level in a non-volatile memory;
an interface module reading said data storage device and communicating with a computer system.

2. The apparatus of claim 1 further including a flexible cable having a first end and a second end, said first end in electrical communication with said interface module and said second end in electrical communication with an electrical connector, whereby said electrical connector provides an electrical communication path between said interface module and said computer system.

3. The apparatus of claim 1 wherein said data storage device stores at least one identification code.

4. The apparatus of claim 1 wherein said data storage device is an electronic device and said interface module is an electrical interface circuit communicating with said data storage device and said computer system.

5. The apparatus of claim 1 wherein said data storage device is a label having optically encoded data and said interface module includes an optical reader sensing said optically encoded data.

6. An apparatus for automatically providing source data for a radiation source, said apparatus comprising:
a radiation source;
a data storage device associated with said radiation source; and
a means for communicating with said data storage device;
whereby said data storage device provides data to a computer system.

7. The apparatus of claim 6 wherein said means for communicating includes a cable in electrical communication with said data storage device and in electrical communication with said computer system.

8. The apparatus of claim 7 wherein said cable has a first end and a second end, said first end in electrical communication with said data storage device, said second end in electrical communication with an electrical connector, whereby said flexible cable and said electrical connector provide an electrical communication path between said data storage device and said computer system.

9. The apparatus of claim 6 wherein said data storage device includes an interface circuit and a non-volatile memory device, said interface circuit enabling communication between said non-volatile memory device and said computer system.

10. The apparatus of claim 9 wherein said data storage device includes a programmable memory device.

11. The apparatus of claim 6 wherein said data storage device includes an interface circuit and a non-volatile memory device, said interface circuit reading said non-volatile memory device and communicating with said computer system.

12. The apparatus of claim 11 wherein said non-volatile memory device is a bar code affixed to said source and wherein said interface circuit is a bar code reader.

13. The apparatus of claim 6 wherein said data storage device stores a date and a source activity level.

14. The apparatus of claim 13 wherein said data storage device stores at least one identification code.

15. The apparatus of claim 6 wherein said radiation source is a coincidence transmission source having a point source rod.

16. An apparatus for automatically providing source data for a radiation source, said apparatus comprising:
a coincidence transmission source;
a means for storing data;
a means for communicating with a computer system;
a means for transferring said stored data to said computer system.

17. A method for automatically providing source data for a radiation source, said method comprising the steps of:
(a) determining an activity level of a radiation source on a specified date;
(b) storing a plurality of datum with said radiation source;
(c) installing said radiation source in a tomograph scanner;
(d) reading said data by a computer system;
(e) acting on said data.

18. The method of claim 17 wherein said step of installing said-radiation source includes the steps of
fixing said radiation source to said tomograph scanner and
connecting said radiation source to said computer system.

19. The method of claim 17 wherein said step of storing data includes storing said activity level and said specified date.

20. The method of claim 17 wherein said step of storing data includes storing a unique serial number for said radiation source.

21. The method of claim 17 wherein said step of storing said data includes storing an identification datum, said identification datum identifying a tomograph scanner in which said radiation source is to be installed.

22. The method of claim 17 wherein said step of acting on said data includes at least one of the steps selected from the group including verifying an identity of said source, notifying an operator of an approaching expiration date, notifying an operator of an incorrect source for a particular tomograph model, making a source-strength correction calculation, and using a unique serial number for regulatory traceability.
